(19) United States
(12) Patent Application Publication
(10) Pub. No.: US 2005/0117332 A1
(43) Pub. Date: Jun. 2, 2005

(54) Lamp for mounting on a building surface or a part of a building surface

(75) Inventor: Tim Henrik Maack, Ludenscheid (DE)

Correspondence Address: THE FIRM OF KARL F ROSS, 5676 RIVERDALE AVENUE, PO BOX 900, RIVERDALE (BRONX), NY, 10471-0900, US

(73) Assignee: ERCO Leuchten GmbH

(21) Appl. No.: 10/931,787

(22) Filed: Sep. 1, 2004

(30) Foreign Application Priority Data
Sep. 4, 2003 (DE) 10341219.0

(51) Int. Cl. F21S 8/00

(52) U.S. Cl. 362/147

(57) ABSTRACT

The invention relates among others to a lamp (10) for mounting on a building surface or a part of a building, like for example on a roof or a ceiling, a wall or a floor of a room, comprising a support device (12) or a plurality of light emitting diodes (29) and a light fitting element (21) which has a light entry area (28) adjoining the support device (12) for light which is supplied by the light emitting diodes (29), a light output area (30) and a light guide segment (27) which connects the light entry area (28) and the light output area (30) with one another. The particular subject matter of interest resides in that the light guide segment (27) has curved internal surfaces (30) and that the light is passed from the light entry area (28) to the light output area (30) through the light guide segment (27) basically with a multiplicity of reflections on the internal surfaces (20).

### CROSS REFERENCE TO RELATED APPLICATION

This application is based upon German application 103 41 219.0 filed 4 Sep. 2003 under 35 USC 119 and the International Convention.

### FIELD OF THE INVENTION

The invention relates to a lamp for mounting on a building surface or a part of a building surface like, for example, on a roof or ceiling, a wall or a floor of a room, comprising a support device for a plurality of light-emitting diodes and a light-emission element which adjoins the support device and encompasses a light-entry area adjacent the support device for the light issuing from the light-emitting diodes, a light-outlet area and a light-guiding segment and which connects the light-entry area and the light-outlet area with one another.

The light-entry area and the light-outlet area are in the sense of this patent application thus components of the light-guide segment but not components of the light-emission element.

In addition, a further light source can be provided. The light from the light-emitting diodes thus constitutes for example an emergency or stand-by light to facilitate or improve the optical characteristics created by the lamp. Thus the light from the light-emitting diodes can be differently colored or can differ in light intensity from the light of the further light source and thus can for example provide accent lighting. Another function of the light outputted by the LEDs can be a contrast reduction in the region of the lamp externally of the further light source.

### BACKGROUND OF THE INVENTION

A lamp of this type is described in EP 1 043 542 A2. Here light-emission plates are provided from which the light of the light-emitting diodes is radiated outwardly. It is proposed there to provide the light-emitting diodes behind, in or laterally of the light-emission plates. In the embodiment of FIG. 2 the light-emission plate surrounds the further light source in a ring-like arrangement.

### OBJECT OF THE INVENTION

The object of the present invention is, starting from EP 1 043 542 A2, to so improve this lamp that with a simpler construction of the lamp, a more homogeneous outputting of the light from the light-emitting diodes through the light-emission elements is enabled.

### SUMMARY OF THE INVENTION

The invention achieves this object in that the light-guide segment has curved internal surfaces and in that, a further transmission from the light-entry area to the light-discharge area is effected through the light-guide segment with basically multiple reflections on these inner surfaces.

The principle of the invention resides basically in that through multiple reflections of the LED light cone on the curved internal surfaces of the light-guide segment, a widening or spreading of the individual light cones and thus a homogenization of the LED light is effected. Thus the inner surfaces of the light-guide segment can be for example at least partly mirrored or so arranged that the LED light is transmitted by means of total reflection. The homogenization of the light improves the overall aesthetic impression provided by the light, in that through the mixing of the light from the light-emitting diodes there is a uniform illumination over the entire light-output area.

The light-guide segment can be configured as a massive or solid body which is comprised of a light-transmissive or transparent material like, for example, glass or a plastic. Through the choice of materials, the equalizing or uniform distribution effect of the light-emitting element can be further improved. The selection of suitable refractive indices and/or the incorporation of light-scattering bodies or defect locations in the material of the light-guide segment can support the light homogenization. It will be self-understood that the internal surfaces of the light-guide segment, of the light-inlet area and/or of the light-discharge area can have a microstructure, like for example a multiplicity of microprisms, which contributes to a very uniform spreading of the light emerging from the lamp. The material of the light-guide segment can also be, for example, colored.

In EP 1 043 542 A2 it has already been proposed to provide the light-emitting plate with finely divided particles effecting a scattering of the light impinging thereon alternatively or additionally thereto, the light output surface of the light-emitting plate can be structured, for example, by roughening the surface or by applying microprisms thereto. The proposed methods have not however been found to be suitable in general applications to provide a homogeneous LED light or are very expensive to carry out technologically.

For the coupling of LED light to the light-emitting plate from the side, it is for example required to provide the scattering bodies in the plate at the parts more remote from the LEDs with a higher density than in the parts which border on the LEDs in order to obtain in all regions a uniform light emission. The fabrication of such a plate must be characterized as having a very high cost.

Also the roughening of the surface of the plate alone or the application of a microprismatic structure thereto has the effect of insufficient homogenization of the light output. For a given structure the degree of homogenization depends upon the spacing from the light-emitting diodes and upon the opening angle of the light cones emitted thereby. A complete homogenization of the light from the light-emitting diodes cannot be attained practically in this manner. The light emission of the light-emitting plate shows a maximum in the vicinity of the light-emitting diodes.

The invention enables, with a simple construction of the lamp, homogenization of the light from the light-emitting diodes. The light-emitting element can be fabricated in an especially simple manner. A technologically expensive fabrication of light-emitting plates with precisely defined scattering-body densities or a structuring of the light-emitting plate matched to the illumination properties of the LEDs is not required. The desired homogenizing effect is obtained already through the multiple reflections of the incident light on curved internal surfaces of the light-guide segment.

According to an advantageous configuration of the invention, the light inlet area is so spaced from the light-outlet area and so arranged relative to it that at most a minor part of the light-outlet area can be projected on the light-inlet area within the light-guide segment. A part of the light-outlet area is then considered projectable on the light-inlet area within the light-guide segment when all points within this part of the area lie along straight lines from the light-outlet area to the light-inlet area which completely run within he light-guide segment. The greater part of the LED light is thus reflected at least once on the inner surfaces of the light-guide segment before it reaches the light-output area.

Because of this configuration of the invention, the shape of the light-emitting element can be of compact construction in spite of a very long light path. Because of the lengthening of the light path, the number of reflections can be increased for the light traveling from the light-inlet area to the light-output area. With this configuration, the light-emitting diodes are spaced in terms of the light path many times the spacing a direct spacing would provide, creating substantially more play or leeway in the shape of the lamp.

The invention also relates in a further aspect, to a lamp which comprises a support device for a multiplicity of light-emitting diodes, a light-emission element which has a light-inlet area proximal to the support device for the light outputted by the light-emitting diodes, a first light-output area and a light-guide segment which connects the light-inlet area and the first light-output area with one another, as well as a receiving device for a second light source and a second light-output area associated with this receiving device.

In this lamp the light-inlet surface is so spaced from the first light-output area and arranged relative to it that at most a minor part of the first light-output area can be projected on the light-inlet area within the light-guide segment.

The principle of this aspect of the invention thus is basically that the light-guide segment should have such a geometric shape that light coming from the light-inlet area cannot reach the first light-output area in a straight line but must be reflected initially by the inner surfaces of the light-guide segment. In that manner the LED light is rendered uniform by such reflections.

With this configuration it is possible to arrange the light-emitting diodes in a spaced relationship from the second light source and to isolate the LED and the second light source thermally at least in major part, thereby substantially increasing the life of the light-emitting diodes. The solution of the present invention thus enables with a simplified construction both thermal isolation and a homogenized light output.

This solution according to the invention has the advantage that the configuration of the light-emitting element is independent from the inlet radiation direction and independent from the opening angle of the light emitted by the LED to effect a homogenization. The light-emission element is so configured that the predominant part of the light outgoing from the light input area undergoes one or more reflection on the internal surfaces of the element and is thus homogenized in passing to the first light output area. Furthermore, the features of claim 3 enable a configuration of the light emitting element such that the light has the longest possible path between the light inlet and light output areas, thereby also contributing to a uniformity of the light output over the output area.

It should be noted that the term “light outlet area” and the term “first light outlet area” in the sense of the present invention always designates the light outlet area of the light emitting element, whereby the designation of “first light outlet area” or “light output area” is used only when a second light source with a second light output area assigned to this source is provided.

According to an advantageous refinement of the invention, the light guide segment has curved internal surfaces and effectively produces a multiplicity of reflections on the internal surfaces of the light segment for the light passing from the light inlet area to the first outlet area through light guide segments. Such multiple reflections on curved surfaces give rise, as has been indicated previously, to a homogenization of the LED light and an improvement in the optical properties of the lamp.

The invention also comprises a lamp which has a carrier device for a multiplicity of light diodes, a light emitting element or light emission element which has a light inlet area adjacent the support device for the light emerging from the light emitting diodes, a first substantially circular ring-shaped light outlet area and a light guide segment which connects the light inlet area and the first light outlet or light output area with one another, a receiving device or socket for a second light source and a second light outlet or light output area assigned to this receiving device and which is surrounded by the first light output area.

Such a lamp is also known from EP 1 043 542 A2. The light emitting element is there, according to FIG. 2, configured as a circular ring-shaped light emitting plate. The light emitting diodes are arranged directly adjacent the light output area, for example directly behind the latter, laterally of the light emitting plate or in the light emitting plate. This circular ring-shaped light emitting plate surrounds a circular disk shaped light output area of a further light source.

The invention however is characterized in that the light emitting element surrounds with a substantially ring-shaped segment and inlet segment, whereby the inlet segment connects the support device of the light emitting diodes with the ring-shaped segment and whereby the height of the ring-shaped segment is greater than its wall thickness.

The principle of this aspect of the invention resides basically in that it provides a light emitting element which enables irradiation by the LED light in the peripheral direction and a further conduction of the light in the peripheral direction. The LED light can be partly homogenized already in the inlet segment by reflection and can pass into the ring-shaped segment in the circumferential direction where it continues on its path through reflections on the curved surfaces of this segment. Through these multiple reflections, the light is further homogenized.

The ring-shaped segment is configured in its height so that its height is greater than the wall thickness in every case and enables the LED light to be propagated along the turns of the ring and will several circulations within the ring-shaped segment before the light emerges therefrom. This effect can be supported in that the LED light is fed into the inlet segment in the circumferential direction. A correspondingly high configuration of the ring-shaped segment enables a further passage of the light with multiple turns around the segment after inputting of the light in the circumferential direction.

The invention thus also enables, with corresponding configuration of the inlet segment, the light diode to be spaced from the second light source. As a consequence, the light emitting diodes can be thermally separated from the second light source which substantially increases the life of the light emitting diodes.

The LEDs can be arranged in mutually neighboring relationship at a common location and can in spite of the fact that they are concentrated at a single location, provide a homogenous illumination of the circular ring-shaped light output area. A spacial distribution of the LEDs is not required. It is thus possible to assemble the light emitting diodes into a single structural unit which simplifies mounting of the LEDs in the lamp and assembly of the lamp since it can be made from preformed structural units.

According to an advantageous configuration of the invention, the ring-shaped segment has a first curvature axis and a second curvature axis, the curvature axis being substantially perpendicular to one another. The first axis of curvature is then for example the central ring axis. In a region of the ring-shaped segment which the second light output surface is adjacent, the ring-shaped segment is for example additionally curved outwardly. This additional curvature increases the number of light reflections and increases thereby the homogenization effect of the light emitting element.

According to a further advantageous refinement of the invention, the light guide segment comprises boundary or limiting surfaces which have a microstructured, especially a prismatically structured shape. On these structures, impinging LED light is strongly scattered and thus further homogenized. The homogeneity of the outputted LED light is thus further increased.

### BRIEF DESCRIPTION OF THE DRAWING

Further advantageous configurations of the invention will become apparent from the following description of an embodiment illustrated in the figures. These show:

FIG. 1 a schematic illustration of an embodiment of a lamp according to the invention in a perspective view,

FIG. 2 the lamp of FIG. 1 in plan view,

FIG. 3 the lamp of FIG. 2 in a side view taken in the direction of the arrow III [(FIG. 2)],

FIG. 4 a section through the lamp of FIG. 2 according to the section line IV-IV,

FIG. 5 a section through the lamp of FIG. 2 according to the section line V-V, and

FIG. 6 the lamp according to FIG. 5 with a pivotal receiving device or socket for a second light source.

### SPECIFIC DESCRIPTION

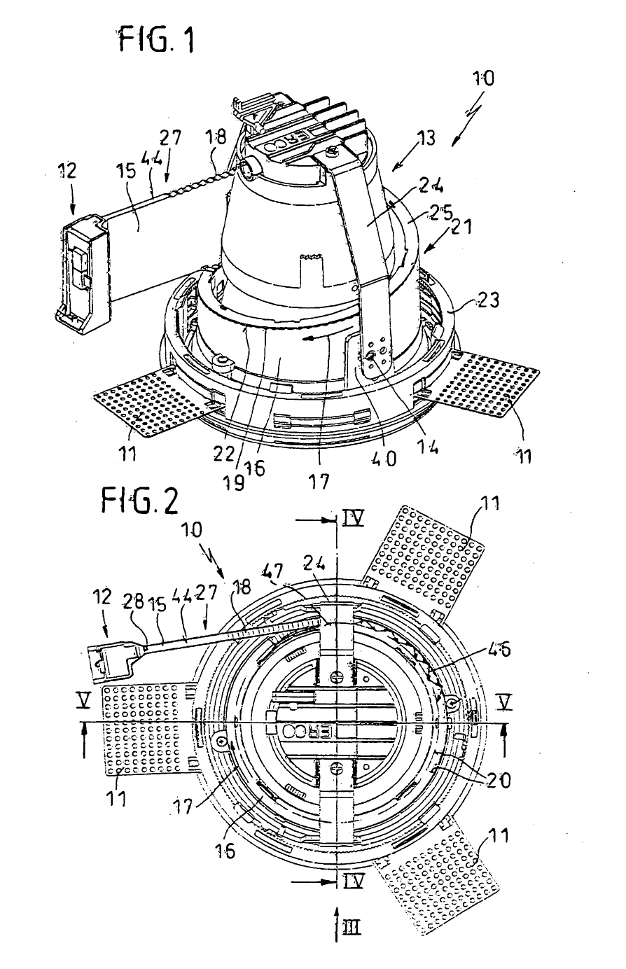

FIG. 1 shows in a perspective view a lamp designated as a whole with the reference character 10 according to the invention. The lamp 10 is basically cup shaped and has a circular ring-shaped frame 23 from which radially projecting plate-shaped fastening elements 11 are connected with which the lamp 10, for example, can be built into a space provided for it in a ceiling wall of a room.

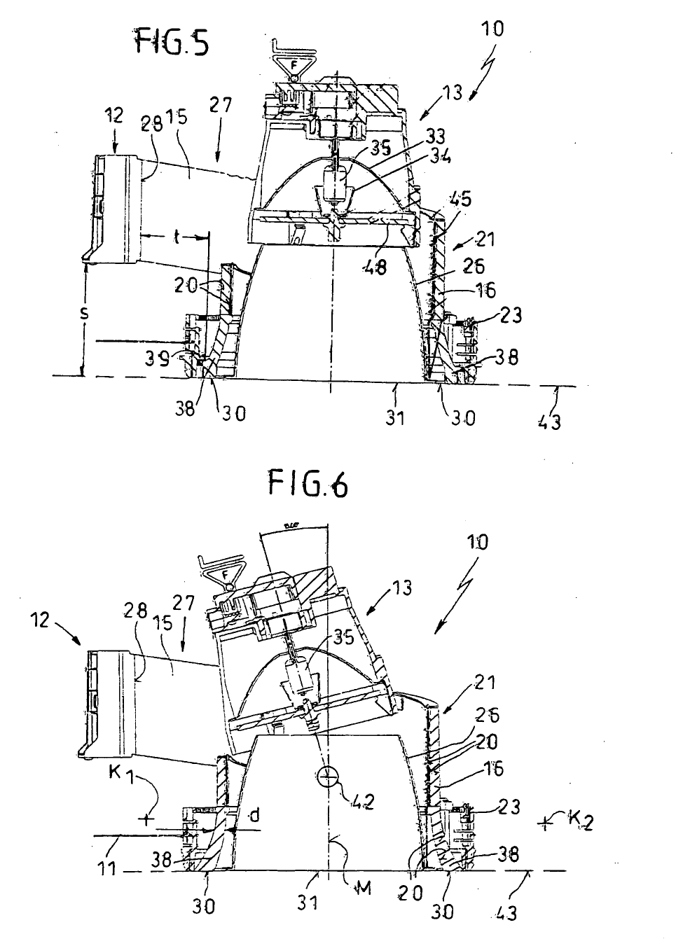

The frame 23 has in addition axially projecting plate-shaped brackets 40 to which a stirrup 24 is connected for a receiving device 13 for a light source 45 illustrated in FIG. 4. The stirrup or strap 24 is connected with the plate shaped bracket 40 through pivots 14 whereby the receiving device 13 is swingable about the axis 42 indicated in FIG. 6. The receiving device 13 can thereby be arrested in the desired position.

The lamp 10 is connected via electric voltage supply lines to a voltage source, whereby the voltage supplying lines have not been shown so as not to obstruct the illustration.

In FIG. 4 the configuration of the receiving device 13 can be discerned. The receiving device 13 comprises a socket 41 upon which the light source 35, for example, a halogen lamp is disposed. The receiving device 13 in addition has a first parabolically shaped reflector 33 and a second substantially funnel shaped reflector 34 which serves to render the light from the light source 34 uniform or homogenous. The predominant part of the light encounters initially the reflector 34 and is then supplied by the reflector 34 to the reflector 33. From the reflector 33 the light is cast upon a scattering disk 48 and passes through this scattering disk or diffusor 48 and then is directed onto a further reflector 26 of the lamp 10 which surrounds a hollow space 32 before emerging from a circular disk-shaped light output area 31 which serves as the region from which the light from the lamp 35 emerges. The arrows 49 indicate the path of the light starting from the light source 35 in a schematic manner.

The reflector 36 is surrounded by a ring-shaped stabilizing element 50 whose lower side forms a circular annular surface 37 which can be seen in FIG. 4 and which directly bounds the light output area or region 31.

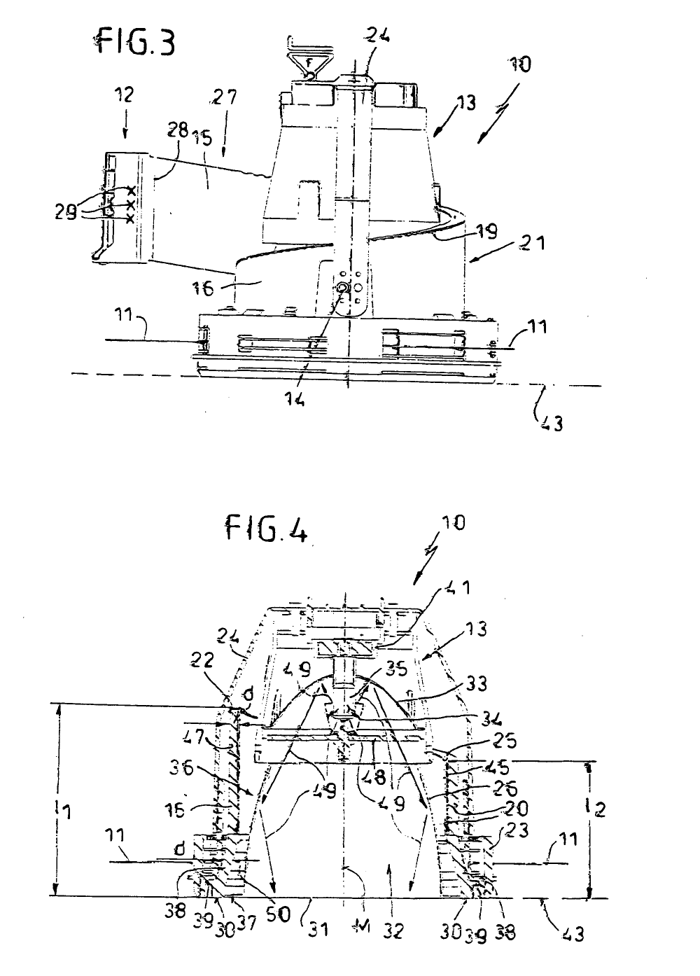

Furthermore, the lamp 10 has a support device 12 which is for example shown in FIG. 3 for a multiplicity of light emitting diodes 29 schematically indicated in FIG. 3. The support device 12 is, as will be later discussed again, spaced from the receiving device 13.

The light emitting diodes 29 constitute, in the sense of this patent application, the first light source. The light source which is received in the receiving is device 13 and is indicated at 35 is the second light source for the purposes of this patent application.

The support device 12 for the light emitting diodes is connected by means of an inlet segment 15, which has basically the shape of an elongated obligate prism with a rectangular base, with an annular or ring-shaped segment 16. The light inlet segment 15 is inclined with respect to the light output area 31 and has a light inlet area 28 for the light from the light emitting diodes 29. The LED light is fed through the light inlet segment 15 via a light inlet area 47 illustrated for example in FIG. 4 and which connects the light inlet segment 15 with the annular segment 16, the light emerging through this area into the ring-shaped segment 15.

As will be apparent from FIG. 2, the light inlet segment 15 is tangential to the ring-shaped segment 16 and thus ensures that the light from the inlet segment 15 will pass into the ring-shaped segment 19 in the circumferential direction 17. The segments 15 and 16 together form a light guide segment 27 which feeds the light from the light emitting diodes 29 in a light guide direction determined by the geometric shape of the light guide segment 27 along a light guide path which in the plan view has substantially the shape of a “p”. The light guide segment 27 can for example be constructed in one piece or in two pieces.

In the illustrated embodiment the light guide segment 27 is constructed as a solid body which can be comprised of a transparent material like for example glass or a transparent plastic, especially PMMA (polymethyl methacrylate). In this case a further passage of the LED light with total reflection at the boundary surfaces is possible. A configuration of the light guide segment 27 as a hollow body is also conceivable. The light guide can then be provided in the form of a segment 27 with mirrored internal surfaces.

As has been illustrated in FIG. 4, the underside of the ring-shaped segment 16 is configured as a circular annular light output area 30 which lies in the plane 43 defined by the light output area 31. The light output area 30 surrounds the light output area 31 and between the light output areas 30 and 31, an element 50 with for example an opaque surface 37 is disposed.

The light output area 30, through which the LED light emerges, constitutes in the sense of this patent application the first light output area; the light output area 31, which is associated with the light source 35 forms the second light output area.

The support device 12 is disposed at the side of the plane 43 at which the receiving device 13 is located and according to FIG. 5 is spaced from the plane 43 by a length s. For this purpose, the support device 12 is located at a distance t along the plane 43 from the first light output area 30 by a distance t. Because of the spacing of the support device 12 from the first light output area 30 as well as perpendicular to the plane 43 (distance s) and along the plane 43 (distance t) the thermal effect on the light diodes 29 by the second light source 35 is largely avoided. In addition, because of this arrangement of the support device 12 a simplified construction of the lamp 10 is possible. The support device 12 can be arranged in an outer region of the lamp 10 at which no other components of the light are disposed so that the support device 12 is easily acceptable and can be mounted in a simple manner.

As has been illustrated in FIGS. 5 and 6, the ring-shaped segment 16 in the region surrounded by the frame 23 has a substantially funnel shaped axially extending segment 38. According to FIG. 5, this segment 38 can have proximal to the plane 43 a step 39. In an alternative configuration of the funnel shaped segment 38, as shown in FIG. 6, the wall thickness increases continuously towards the plane 43; no steps are provided. In both embodiments, the segment 38 has, in addition to a curvature in the circumferential direction 17 about the axis of curvature M, a curvature in at least one additional direction. In the embodiment illustrated, the axial segment 38 curves about a curvature axis which in FIG. 6 has been represented by the points K₁ and K₂ but has the configuration of a circle which surrounds the axial segment 38.

The light inlet area 28 the light guide segment 27 and the light outlet area 30 form collectively a light emitting element 21. The light guide segment 27 and the light emitting element differ in that the light emitting element 21, by contrast to the light guide segment 27, also encompasses the light inlet area 28 and the light outlet for output area 30.

The light from the light emitting diodes 29 and the light from the second light source 35 can differ in color or also in intensity. Both light sources 29, 35 can simultaneously emit light although this is not essential. The light sources 29, 35 can be provided with voltage supply and control devices which enable independent control of the two light sources 29, 35. The control device for the light emitting diodes 29 can be provided for example in the support device 12. The control device for the second light source 35 can be disposed for example in the receiving unit 13 associated therewith.

It is conceivable to so control the lamp 10 that for example initially only the light emitting diodes 29 emit light and thus can serve for emergency lighting. The two light sources 29, 35 can both emit light so that the light emitting diode light for example will have the function of accent lighting. The light emitting diode light can also be used for contrast reduction in the region of the second light output area 31. Especially, both light sources 29 and 35 can be configured to be dimmable.

Through the described geometric shape of the light emitting element 21 and especially good mixing and homogenization of the light supplied by the light emitting diodes 29 can be achieved. A possible light path 26 has been schematically illustrated in FIG. 2 by an arrow line in a kind of zigzag line. To prevent confusion, only the beginning of the light path 46 in the vicinity of the inlet segment 15 has been illustrated. The greater part of the LED light traverses the annular segment 16 a number of times in the circumferential direction 17 before it encounters the first light output area 30 and emerges from the lamp 10. These reflections are effected predominantly on the curved internal surfaces 20 of the light emitting element 21. With each reflection the LED light cone is widened or spread as mixing is effective.

In the embodiment provided as an example, for optimizing the mixing and homogenization of the light and the upper boundary area 44 (compare FIG. 1) of the inlet segment 15, a prismatic structure 18 is provided. Prismatic structures 19 are also provided at the upper boundary surfaces 22 of the annular segment 16. Through the structures 18 and 19, a scattering of the LED light which may encounter them is ensured.

As has been illustrated in FIG. 4, the annular segment 16 is separated by a tubular shielding element 45 from the internal space 36 of the lamp 10. This prevents a penetration of the light from the second light source 35 into the light emitting element 21 to any significant extent. A further shielding element 35 can, as shown in FIG. 4, be provided above the upper boundary surface 22 of the annular segment 16.

In the embodiment described, the light inlet area 28 is so spaced from the first light output area 30 and arranged relative to the latter that no part of the first light output area 30 lies within a projection of the light inlet area 28 within the light guide segment 27. This is significant since no point of the first light output area 30 can be connected by a straight line with a point of the light inlet area 28 which lies fully within the light guide segment 27. Because of this configuration, in a compact configuration of the light emitting element 21, a very long light path can be provided between the light inlet area 28 and the light output area 30.

FIG. 4 shows the relationship between the different heights I₁ and I₂ of the annular segment 16 and its wall thickness d. In the example, the heights I₁ and I₂ are greater, especially clearly greater, than the wall thickness d. As a consequence, a multiple circulating traverse of the LED light within the annular segment 16 and a homogenous light output is ensured.

The height of the annular segment 16 decreases in the circumferential direction 17 starting from the area 47 at which the inlet segment 17 transitions to the annular segment 16 (height I₁). At about 180° from the area 47 in the circumferential direction 17, the annular segment 16 has the smaller height I₂. Because of this continuous reduction in the height of the annular segment 16, a constant energy density of the LED light within the light emitting element 21 can be achieved and therewith and especially homogenous light output. Finally it can be noted that a lamp according to the illustrated embodiment, even with relatively very few light emitting diodes, for example a red, a green and a blue light emitting diode, has a very homogenous light output of the LED light.

1. A lamp for mounting on a building surface or a part of a building surface, like for example on a roof or ceiling, a wall or a floor of a room, comprising a support device for a plurality of light emitting diodes and a light emitting element which has adjacent the support device a light entry area for the light emerging from the light emitting diode, a light output area and a light guide segment which connects the light entry area and the light output area with one another, the light guide segment having curved internal surfaces such that the passage of the light from the light entry area to the light output area is effected through the light guide segment with substantially a multiple reflection on the internal surfaces.

2. The lamp according to claim 1 wherein the light entry area is so spaced from the light output area and oriented relative thereto, that at most a minor part of the light output area can be projected upon the light entry area within the light guide segment.

3. A lamp for mounting on a building surface or a portion of a building surface, like for example on a roof or ceiling, a wall or a floor of a room, comprising a support device for a plurality of light emitting diodes, a light emitting element which has a light entry area neighboring the support device for light emerging from the light emitting diodes, a first light output area and a light guide segment which connects the light entry area and the first light output area with one another, as well as a receiving device for a second light source and a second light output area associated with this receiving device, the light entry area being so spaced from the first light output area and oriented relative to it that at most a minor part of the first light output area can be projected on the light entry area within the light guide segment.

4. The lamp according to claim 3 wherein the light guide segment has curved internal surfaces and that the passage of the light from the light entry area to the first light output area is effected through the light guide segment basically over multiple reflections at the inner surfaces.

5. A lamp for mounting on a building surface or on a part of a building like for example on a roof or ceiling, a wall or a floor of a room, especially in accordance with one of the preceding claims, comprising a support device for a plurality of light emitting diodes, a light emitting element which has a light entry area proximal to the support device for the light emerging from the light emitting diodes, a first substantially circular ring-shaped light outlet area and a light guide segment which connects the light entry area and the first light output area with one another, a receiving device for a second light source and a second light output area assigned to this receiving device and which is surrounded by the first light output area, characterized in that the light emitting element having a substantially ring-shaped segment and an entry segment, whereby the light entry segment connects the support device of the light emitting diodes with the ring-shaped segment and whereby the height (I₁, I₂) of the ring-shaped segment is greater than its wall thickness (d).

6. The lamp according to claim 5 wherein the light from the light emitting diodes is directed in a circumferential direction into the ring-shaped segment and is guided within the ring-shaped segment substantially in the circumferential direction.

7. The lamp according to claim 5 wherein the ring-shaped segment widens in cross section towards the first light output area in a funnel shaped manner.

8. The lamp according to claim 5 wherein the wall thickness (d) of the ring-shaped segment increases towards the first light output area.

9. The lamp according to claim 5 wherein the ring-shaped segment has a first axis of curvature (M) and a second axis of curvature (K₁ K₂) which are substantially perpendicular to one another.

10. The lamp according to claim 1 wherein the light emitting element comprises a ring-shaped segment and a light entry segment extending this segment tangentially.

11. The lamp according to claim 1 wherein the light output area of the light emitting element lies basically in a plane, the support device is spaced from this plane, and in that the support device is spaced along the plane from the light output area.

12. The lamp according to claim 1 wherein the light emitting element has a ring-shaped segment which narrows starting from a location at which the LED light is introduced into the ring-shaped segment in the circumferential direction.

13. The lamp according to claim 1 wherein the light emitting element is a solid element comprised of a transparent material like for example glass or plastic, especially PMMA.

14. A lamp according to claim 1 wherein said light emitting element comprises inner internal surfaces which are at least partially mirrored.

15. The lamp according to claim 1 wherein within the light emitting element total reflection is provided.

16. A lamp according to claim 1 wherein light emitting diodes are assembled to a single structural unit.

17. The lamp according to claim 1 wherein the light guide segment has boundary surfaces that have a micro structured configuration, especially a prismatically structured shape.
